(19) United States
(12) Patent Application Publication
(10) Pub. No.: US 2016/0148242 A1
(43) Pub. Date: May 26, 2016

(54) AUTOMATIC GENERATION OF PERSONALIZED REWARD POINTS

(71) Applicant: International Business Machines Corporation, Armonk, NY (US)

(72) Inventors: Michael Desmond, White Plains, NY (US); Sophia Krasikov, Katonah, NY (US); Juan Fernando Mancilla Caceres, Redmond, WA (US); Harini Srinivasan, Tarrytown, NY (US); Emmanuel Yashchin, Yorktown Heights, NY (US)

(21) Appl. No.: 14/552,528

(22) Filed: Nov. 25, 2014

(51) Int. Cl. G06Q 30/02

(52) U.S. Cl. CPC G06Q 30/0226

(57) ABSTRACT

A set of current and historical electronic activity data are received from a customer. The activity data corresponds to the customer's interaction with an electronic product entry within a store. One or more electronic activities can be associated with one or more predetermined seller objectives. The seller's objectives are based on maximizing financial profit and minimizing cost of reward distribution. A reward score value is assigned to a customer based on an association between one or more of the customer's electronic activities and one or more of the predetermined seller objectives. A reward is selected based on the reward score wherein the rewards are also associated with one or more of the predetermined seller objectives, also based on the reward score value. The selected reward associated with the calculated reward score is communicated to the customer.

### BACKGROUND

The present invention relates generally to the field of data processing, and more particularly to a rewards system that distributes promotions to customers.

Electronic commerce methods in use today include the use of promotions or incentives such as rewards programs. Such incentives may be conveyed to prospective buyers through electronic communication such as email, text messages, social network notifications, or electronic coupons in mobile applications. Customers can respond to incentives (thereby accumulating various rewards) by performing a variety of activities. It is advantageous for businesses to optimally determine the willingness of a customer to engage in various activities.

Current reward systems are inadequate because current reward systems may focus on providing customers with ways to spend accumulated rewards however a seller or retailer may want to focus on the distribution of rewards as a method of enticing customers to engage with the store in various ways. Increased engagement with the customer as well as increase loyalty may provide a retailer with an increase in exposure or sales. However, not all customers react to the same incentives the same way or have the same engagement levels. Optimization formulation can be used to find the appropriate incentives to motivate various customers' behaviors. The formulation can mathematically represent an objective to both maximize the store's profit and optimally distribute pre-set promotional resources among customers.

### SUMMARY

Embodiments of the present invention disclose a method, computer program product, and system for providing personalized rewards to users of a computer system. A set of current and historical electronic activity data are received from a customer. The activity data corresponds to the customer's interaction with an electronic product entry within a store. One or more electronic activities can be associated with one or more predetermined seller objectives. The seller's objectives are based on maximizing financial profit and minimizing cost of reward distribution. A reward score value is assigned to a customer based on an association between one or more of the customer's electronic activities and one or more of the predetermined seller objectives. A reward is selected based on the reward score wherein the rewards are also associated with one or more of the predetermined seller objectives, also based on the reward score value. The selected reward associated with the calculated reward score is communicated to the customer.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a functional block diagram illustrating components of an application of FIG. 1, in accordance with an embodiment of the present invention.

FIG. 3 is a flowchart depicting operational steps of a dynamic rewards system on a server computer within the data processing environment of FIG. 1, for determining the proper rewards for specific customers, in accordance with an embodiment of the present invention.

FIG. 4 depicts a block diagram of components of a computing device, in accordance with an embodiment of the present invention.

### DETAILED DESCRIPTION

Offering rewards may be a method that may encourage an increase a customer's use of a particular store or increase engagement in an ecommerce retail store. Increased engagement may increase sales. The dissemination of rewards may be accomplished through the use of profiles, as described below. Use of rewards may encourage customers to engage in activities that are already being performed, for example, writing a review, writing reviews in a particular category, responding to a review, adding a video of how the product is used or installed, recommending products to a friend, recommending a product to a community, accepting or rejecting recommendations, buying a product, browsing a product or a product category followed by a transaction, taking quizzes about products, filling out surveys about the store or products, posting a social media message related to the store or the store's product, or social media geographical checking-ins when in the store.

In various embodiments, rewards may be used to encourage a customer to keep doing what he/she is already motivated to do or to encourage a customer to perform activities they would otherwise not do. For example, by offering a reward for writing a review on an item that a customer purchased but has yet to write a review on. Both positive and negative customer's review about the purchased product is valuable as it increases the reliability and accountability of a store likely leading to an increase of the number of sales of this particular product or other products in the future. Thus, embodiments of the invention consider one or more activities performed by the customers in the online store as positive because they might increase the store's revenue and profitability. All activities may be recorded in a profile associated with a specific customer, as described below.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

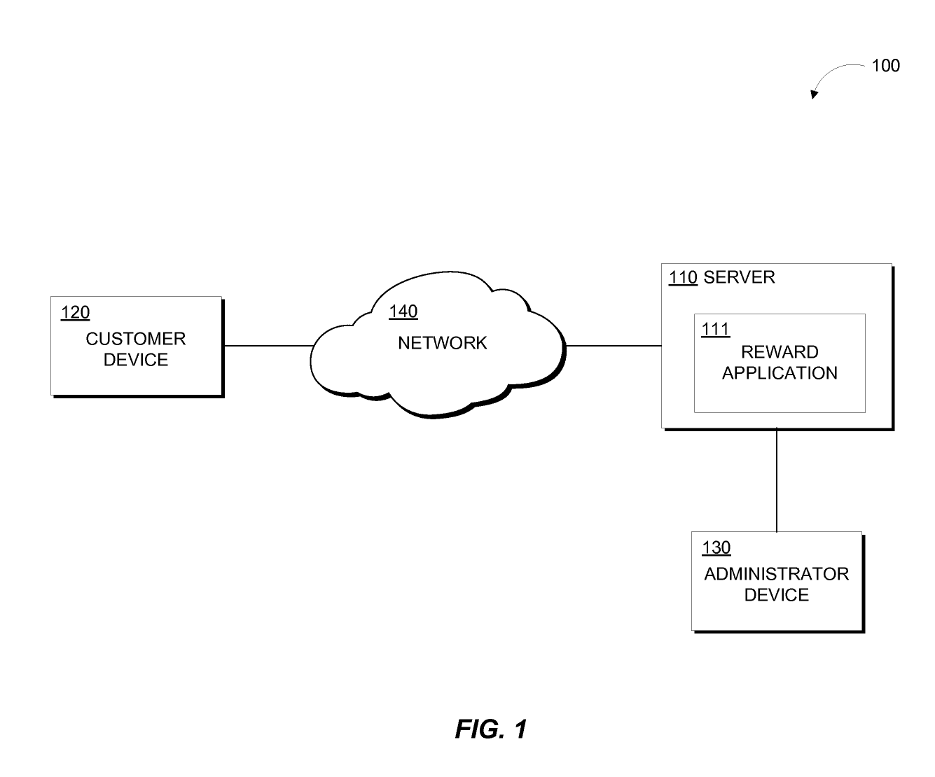

Embodiments of the present invention will now be described in detail with reference to the Figures. FIG. 1 is a functional block diagram illustrating a distributed data processing environment, generally designated 100, in accordance with an embodiment of the present invention.

Distributed data processing environment 100 includes server 110, customer device 120, and administrator device 130, all interconnected over network 140.

Network 140 may include permanent connections, such as wire or fiber optic cables, or temporary connections made through telephone or wireless communications. Network 140 may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Network 140 may also include a number of different types of networks, such as, for example, an intranet, a local area network (LAN), or a wide area network (WAN).

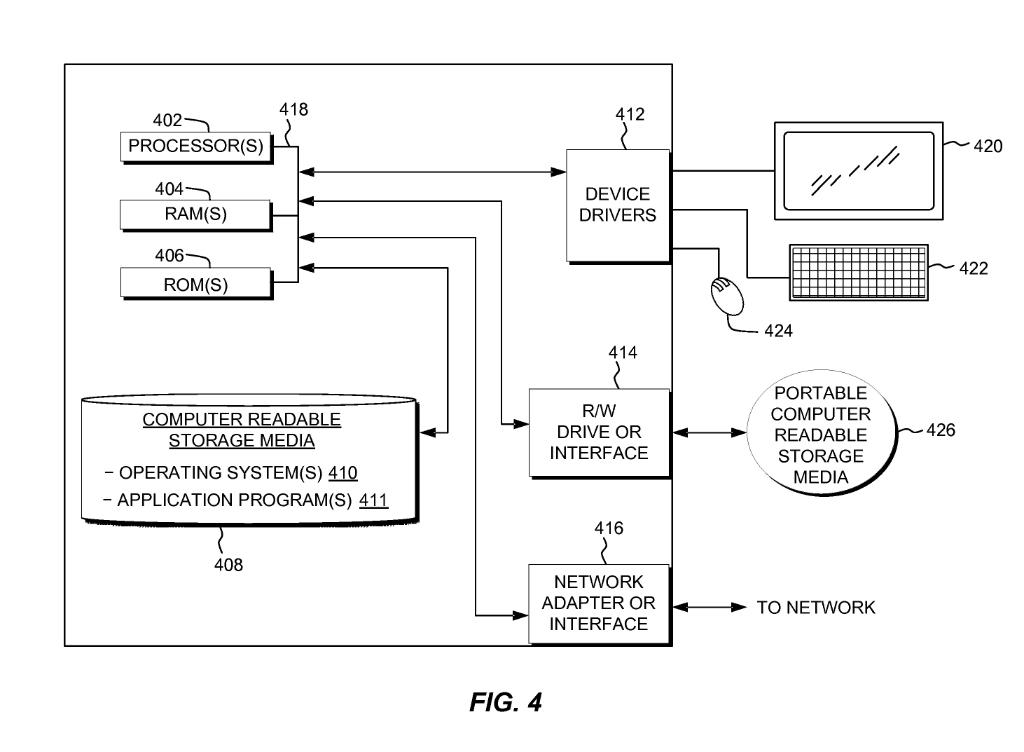

Each of server 110, customer device 120, and administrator device 130, may be a laptop computer, tablet computer, netbook computer, personal computer (PC), desktop computer, smart phone, or any programmable electronic device capable of an exchange of data packets with other electronic devices, for example, through a network adapter, in accordance with an embodiment of the invention, and which may be described generally with respect to FIG. 4 below.

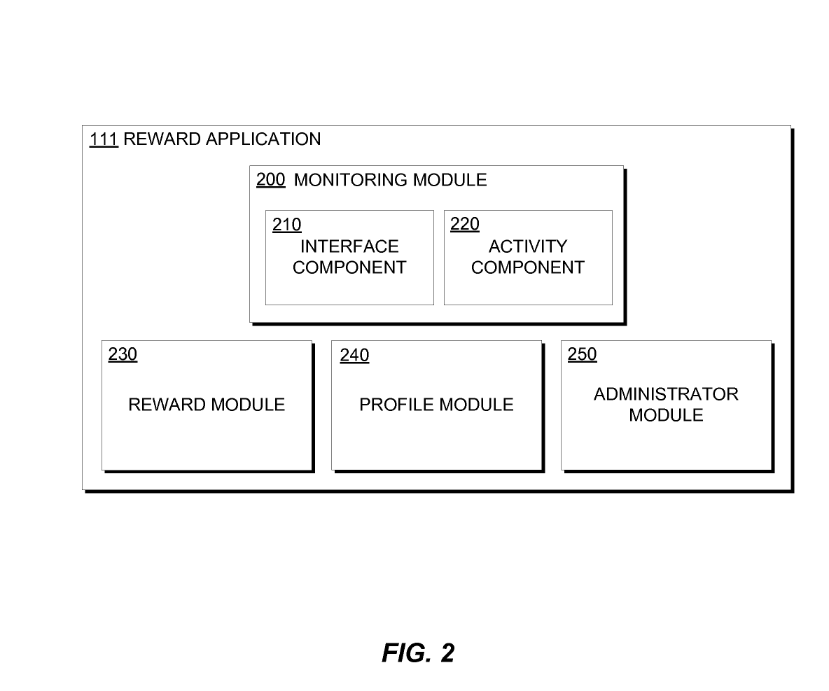

Server 110 includes reward application 111, as described below, in reference to FIG. 2. In various embodiments of the invention, server 110 operates generally to receive data from customers via client devices, for example, customer device 120, receive rewards data from administrators via administrative devices, for example, administrator device 130, and to host applications, for example, reward application 111.

Reward application 111 may be database oriented, computation oriented, or a combination of these. Reward application 111 may operate generally to receive subscription requests, generate and store profiles associated with subscriptions, receive and record activity data associated with store customers, calculate a reward score, described below, based on customer activity data and profile data associated with the customer, and communicate rewards based on the reward score. “Activity data” may include any data received by rewards application 111 associated with an interaction a user or customer has with rewards application 111. Activity data may include interaction a customer has with a graphical user interface (GUI) on customer device 120 and may be received by rewards application 111 via server 110. Activity data may include, for example, an electronic review, an electronic purchase, a social media posting, or completion of an electronic survey. Further examples may include a customer review of a specific product, a customer review of a specific product category, a response to a previously posted review, a video visualizing how the product is used or installed onto a forum related to the product, a customer recommending products via social media, a customer accepting or rejecting recommendations, a customer purchasing a product, a customer browsing and selecting a product for future purchase, a customer selecting a product followed by a transaction, a customer taking quizzes about various products, a customer filling out surveys about a store or products, a customer posting information on social media about a store or product, a customer sharing geographical data on social media (e.g. “check-ins”), or a customer agreeing or disagreeing with product reviews posted by other customers.

Rewards may be associated with a predetermined reward score. Rewards may be, for example, an instant percentage discount on current purchases, a coupon for a monetary discount or percentage off of the cost of a future product purchase, an electronic customer acknowledgement on social media (e.g. “tag”), receipt of additional or “bonus” products as a result of a transaction, sample products, admittance to a higher class or tier of rewards or reward score multiplier, or another item or incentive that may encourage a customer to interact with a store.

In an embodiment of the invention, customer device 120 may operate generally to send and receive product data, send and receive activity data, send and receive subscription information, and receive rewards. Customer device 120 may communicate with server 110 through network 140. Customer device 120 may receive input from a customer, display data in a GUI, or communicate over a network, for example, a web browser. Customer device 120 may allow a customer to input various media, including but not limited to, audio, video, pictures, or text.

Administrator device 130 may operate generally to receive input from an administrative user. Administrator device 130 may configure or define, for example, the objectives of the retailer or ecommerce store, currently available rewards associated with the objectives, the time period that rewards are available, rewards available for a specified activity or activity category, or the reward score needed to obtain a reward. Administrator device 130 may predetermine, for example, how much activity performed by a customer to yield the sufficient reward score to obtain a reward, which may include, for example, a coupon, monetary discount, limited time special offer, or various other promotions as described above. Administrator device 130 may communicate values of various variables to reward module 230, as described below, in accordance with an embodiment of the invention.

FIG. 2 is a functional block diagram illustrating the components of reward application 111. Reward application 111 includes monitoring module 200, reward module 230, profile module 240, and administrator module 250. FIG. 2 also includes the components of monitoring module 200, interface component 210 and activity component 220.

In an exemplary embodiment of the invention, monitoring module 200 may act generally to receive activity data from a customer's device, which may include, for example, customer device 120, and communicate a reward score or associated rewards received from reward module 230, as described below. Monitoring module 200 includes interface component 210 and activity component 220.

Interface component 210 may act generally to receive activity data from a customer, for example, customer device 120. Activity data may include any data received by interface component 210 associated with a customer's interface component 210. This may be a customer interaction with the customer interface via customer device 120. Activity data may be historical or current, which correspond to data activity data received before a predetermined time period, indicating historical activity data, or before a predetermined time period, indicating current activity data. Historical activity data may include, for example, a purchase history for a predetermined timeframe or previous interactions with reward application 111 that were not previously associated with a profile. Current activity data may include, for example, data received by reward application 111, during the customer's current login session, that may start when reward application 111 receives login information from a customer as described below. In an embodiment of the invention, interface component 210 may receive a query from customer device 120, for example, to subscribe to reward application 111 and/or create a profile. Interface component 210 may send a message to customer device 120 to provide an identification. An identification may include, for example, a CAPTCHA, an email address, social media access information, customer identification (ID) name and password, geographical information, or another combination or method of verification in accordance with an embodiment of the invention. In an embodiment of the invention, identification data received by interface component 210 may be passed to profile module 240, and rewards received from reward module 230 may be communicated to the customer associated with the received customer ID, as described below.

Activity component 220 may receive activity data passed from interface module 210. In an embodiment of the invention, activity component 220 may store the activity data in memory. Activity component 220 may parse the activity data and organize the activity data by type (e.g. current or historical) by arranging the activity data in, for example, an “activity category.” Activity component 220 may identify one or more activities within the received activity data that is associated with one or more objectives received by administrator module 250. Activity component 220 may associate the activity category with the received activity data from an associated customer ID. Activity component 220 may pass the organized activity data and associated ID to profile module 240. In various embodiments of the invention, activity component 220 may receive instructions from an administrator, for example, administrator device 130, via administrator module 250 described below, to only store or communicate data of a certain category that is predetermined as desirable. In various embodiments, received activity data classified within an undesired category may be deleted.

Profile module 240 may act generally to receive subscription data from a customer, for example, customer device 120, via monitoring module 200, activity data from monitoring module 200, and associate activity data with a profile subscription. Profile module 240 may receive activity data from monitoring module 200 and generate profiles containing activity data received from a customer associated with the identification information received from that customer.

In an embodiment of the invention, profile module 240 may generate a list of profiles in memory of customer ID's and the activity data associated with the ID's. Profile module 240 may organize the profiles into profile categories. Profile module 240 may associate a profile with a profile category label if a predetermined threshold of activity data of a predetermined activity category is associated with a profile. For example, a profile with a percentage of purchase activity data and a lesser percentage of review post activity, or any other activity data, may be categorized as a “frequent purchaser.” Other categories may include, but are not limited to, “frequent reviewer,” “frequent responder to reviews,” or “frequent quiz taker,” where the most prevalent activity data associated with a profile will cause the profile to be categorized as a type of profile associated with the name of the most prevalent activity data.

Reward module 230 may act generally to calculate a reward score, which may be associated with rewards, in a list in memory of predetermined rewards and associated scores to obtain those rewards. Reward module 230 may receive the list of rewards from an administrator, for example, via administrator module 250. The reward(s) assigned to a customer profile may be based on the calculated reward score in which a rewards score of “n” will be associated with rewards “a.” For example a rewards score of “n” may be associated with “n” reward points, or a single monetary coupon. Various reward scores may be calculated based on different activities. In an exemplary embodiment of the invention the calculations made by reward module 230 may be implemented as described below with reference to Equations (1)-(4); an alternative embodiment is described in reference to Equations (5) and (6).

In an embodiment of the invention, reward module 230 may calculate a reward score based on a customer objective, the cost to a customer, the revenue of a retailer, and the optimal reward for a customer. Calculating the customer objective and the cost to a customer may determine what predetermined rewards, associated with the calculated score, the retailer may make available to the customer in order to increase the customer's engagement with a store, which may increase sales revenue or profits. Determining the customer objective and the cost incurred by the customer by engaging in an activity may affect the amount of rewards a retailer makes available, how long rewards are available after distribution the cost of products, the amount the reward is worth, or the reward score needed to obtain the reward.

Reward module 230 may calculate the customer objective. The customer objective may represent the customer's willingness to engage in a particular activity or number of activities, in a particular store, and how rewards may affect that engagement. The customer objective may be represented as a vector representing the intrinsic value of each possible activity available to the customer (v), a vector representing the reward received for the performance of each activity (r), a vector representing the number of activities that were performed (x), and a coefficient (b) representing the amount of value rewards have to the customer or the incentive the reward may provide to the customer to engage in an activity. In various embodiments of the invention, reward module 230 may make calculations based on one or more activities, or a predetermined set of activities.

One way of representing the customer objective is:

(v^{T}+br^{T})x (Equation 1)

Reward module 230 may calculate the cost of activities incurred by a customer. The cost to the customer may include, for example, an expenditure of time, monetary cost to engage in the activity, or effort needed to engage in the activity. The cost a customer incurs by performing an activity may be quantified, for example, as the amount of time required to perform the activity, the amount of time the activity takes to complete, or the amount of money received or spent performing an activity. The output of calculating the cost to the customer may determine cost of a reward to a retailer, for example, a high customer cost may prevent customer engagement and reduce a retailer's revenue and a retailer may increase reward availability to increase customer engagement. Reward module 230 may receive the output of the customer objective (Equation 1), as described above, and, with other constrains that affect customer willingness, as described below, calculate the customer's willingness, as the cost of an activity incurred by the customer. This may be represented using a vector representing the cost to the customer (c), a value of the customer's budgeted cost (B), a coefficient of how much the reward will affect the cost of each activity (g), and a vector representing the reward received by the customer (r). The number of activities that may be taken by a customer (x) is in a finite number greater or equal to zero bounded by a finite limit X (0≦x≦X).

Reward module 230 may formulate the cost of an activity a customer incurs by combining the customer objective (Equation 1) and the constraints defined above, into an linear integer problem that may be solved for each activity performed by a customer, where x may be an integer or non-integer but constrained by a predetermined finite limit X.

max(v^{T}+br^{T})x

subject to:(c^{T}−gr^{T})x≦B

0≦x≦X (Equation 2)

Values of v, c, and B in Equation 2 may be calculated based on the profile associated with the customer ID. Reward module 230 may use activity data from profile module 240, for example, the products browsed, bought, or reviewed, etc., to determine the interests of the customer. If no previous activity data is available for the associated ID, an estimation of interest may be determined by using generic data, for example, market segment data that the customer belongs to or demographic data from the customer's subscription to profile module 240. The values of b and g may be initialized to any reasonable value between 0 and 1 as the initial decision may not be based off of the profile history associated with the customer but may be based on market data for a typical demographic of the store, the historical motivation for activities for that time of day/month/year at that store, a special event held by the store, or another data set that would affect the customer budget for activities or the effect a reward would have on a customer.

The values of b and g may not be limited to the integers 0 and 1. The values for b and g may be any real number value. The value of g reflects a benefit to the customer, for example, the number of points a customer would receive for x activities. The value for b may be any predetermined value that represents an indirect value to the customer.

For example, Customer A performs “activity A” and reward module 230 uses a value of 1 for g based on activity A and the number of points activity A yields. Reward module 230 initiates a value of 1 for b, where 1 is predetermined for all customers with less than 100 activities within a calendar year. Customer B performs activity A and reward module 230 uses a value of 1 for g but a value of 2 for b as Customer B performed over 100 activities within a calendar year.

Reward module 230 may calculate the cost to the store, or revenue acquired due to the distribution of rewards. Reward module 230 may calculate the revenue of the store based the cost the store is willing to incur to attract a customer to engage in an activity, represented as a vector (s), the store's losses incurred due to the distribution of rewards (a), and a vector (r) representing the reward received by the customer the reward received by the customer for an activity, and the number of activities (x).

One way to represent the revenue of the store:

(s^{T}−ar^{T})x (Equation 3)

Rewards distributed by the store for a customer activity may be constrained to limit the overall rewards that are distributed. Reward module 230 may have a predetermined maximum number of rewards that can be distributed (R). Reward module 230 may use variables described above to provide a reward, predetermined as associated with a reward score, or optimal reward score, based on the maximum revenue for the store.

The estimation of v, c, b, g, and B may be calculated through statistical analysis of the customer history using various applications, for example, IBM Cplex®, where the solution to the integer problem can be represented by function “ψ.” The maximum revenue of the store may be formulated as a programming problem:

max(s^{T}+ar^{T})x

subject to:r^{T}x≦R

x=ψ(r,v,c,b,g,B) (Equation 4)

In various embodiments, the value of x, the number of activities performed, does not have to be an integer. The equations described above use a discrete value for x as the magnitude to reflect the number of times a customer performed an activity. The magnitude represented by x may be continuous for some measured activity of the customer, for example, the amount of time “Customer A” took to write “Review B.” In another embodiment, the value of x may be a numerically mixed magnitude, for example, the time Customer A took (continuous) to perform 3 review activities (discrete). All brand names and/or trademarks used herein are the property of their respective owners.

In an alternative embodiment, reward module 230 may calculate a reward score taking based on a customer's preference in rewards. Customers may prefer a consumable reward, yielding an immediate benefit, for example, 100 bonus points or an instant 10% off coupon. Alternatively, customers may prefer a long term or “status” reward, for example, upgrading a customer from gold to platinum level so that (yielding twice the reward score for the same number of activities performed), incurring prestige on social media, or an acknowledgement, by the store, that the customers has achieved a certain reward score total (e.g. “scored 1 million”). The difference in the value customers' place on short term or long term rewards may be represented by the coefficients “g” and “g₀.” The value of g may represent a calibration parameter, or coefficient, used to estimate the immediate offset of the cost to a consumer an activity would incur. The value of g₀ may represent a calibration parameter, or coefficient, used to obtain the long term value to a consumer per activity the reward will yield, for example, frequent flyer miles may not be usable immediately but may be accumulated over time for a larger future redemption.

The reward score may be represented by the customer objective (Equation 1), a vector representing the reward received for the performance of each activity (r), a vector representing the cost to the customer (c), a vector representing the number of activities that were taken (x), the short term and long term values a reward may have to a customer described above, (g and g₀), and a coefficient (w) representing the weight a reward has on the activities of a customer whether short term or long term, having an estimated value between 0 and 1.

The value of w may be estimated from customer data, for example, the profile history of a customer. For example, if the profile history of a customer contains a number of reward redemptions within a predetermined amount of time, which may classify the redemption as “immediate,” reward module 230 may set the value of w to 0. If a customer's profile history contains rewards that have not been redeemed for a predetermined amount of time, for example, accumulated points or accumulated monetary discounts, the rewards may be classified as “long term” and reward module 230 may set the value of w to 1. In various embodiments of the invention, the value of w may be determined as a value between 0 and 1 depending on the activity of a customer recorded in the profile history associated with the customer and the predetermined thresholds for “immediate rewards,” “long term rewards,” and the frequency of a customer's use different classified rewards.

The maximum reward score may be formulated as a programming problem, where x may be an integer or non-integer but constrained by a predetermined finite limit X:

arg max w(v^{T}+br^{T})x+(1−w)(gₒr^{T}−c^{T})x

subject to:(c^{T}−gr^{T})x≦B

0≦x≦X,integer (Equation 5)

In various embodiments of the invention, the estimation of r, v, c, b, g, B, g₀, and w can be calculated through statistical analysis of the customer history using various applications, for example, IBM Cplex®, where the solution to the integer problem can be represented by function “ψ” and the following equation:

max(s^{T}−ar^{T})ψ(r,v,c,b,g,B,g₀,w)

subject to:

r^{T}ψ(r,v,c,b,g,B,g0,w)≦R,r≧0 (Equation 6)

Reward module 230 may calculate cost of an activity on the customer, using Equation 2 described above, by calculating the maximum value of the customer's objective, for example, using Equation 1 described above. Reward module may calculate maximum revenue, for example using Equation 4 above, using the output of the cost of the customer and finding the maximum reward score a customer would receive by calculating the maximum activities a customer would perform and the amount of rewards those activities would generate. In various embodiments of the invention, the output of the value of the reward score may determine how many rewards (points, coupons, discounts, etc.) will be communicated to a customer via customer device 120, or passed and stored in profile module 240 in a list of rewards in a profile associated with the customer.

Reward module 230 may be implemented, where x is not an integer, by using nonlinear optimization, for example, the IBM Program Product CPLEX®, or, where x is an integer, for example, IBM ILOG CPLEX®.

An example of one possible solution using the CPLEX® software may occur by select an initial value of r (r₀), for example, r₀=0. This point may satisfy the constraints of Equation 4. The software may compute ψ (r, v, c, b, g, B, g0, w), the consumer's activities in response to stimulus r₀. The software may compute the value of an objective function (ƒ₀) corresponding to stimulus r₀, for example, ƒ₀=(s^{T}−ar₀^{T})ψ(r₀, v, c, b, g, B, g₀, w). By exploring values of r around point r₀, via CPLEX®, a value “\tilde{r}₀” may be found that is feasible and increases the value of the objective function ƒ₀. The objective function ƒ₀ becomes “\tilde{ƒ}₀” which equals (s^{T}−a\tilde{r}₀^{T})ψ(\tilde{r}₀, v, c, b, g, B, g₀, w). The search, by the software, for a suitable can involve, for example, a search on a grid via methods of statistical design of experiments (DOE), random search, or other search methods. If no value of \tilde{r}₀ is found then the software may exit and output r₀ as a solution to the problem.

Using the vector (\tilde{r}₀−r₀), as the improving direction of values, the software may conduct a linear search in this direction until a value, “r₁” is determined where r₁=r₀+α(\tilde{r}₀−r₀) is found such that r₁ is feasible and r₁ increases the value of the objective function. The objective function ƒ₀ becomes ƒ₁, which may be defined as ƒ₁ which becomes ƒ₁=(s^{T}−ar₁^{T})ψ(r₁, v, c, b, g, B, g₀, w). The value “α” is a value calculated such that ƒ₁ attains the largest value along the direction of the vector (\tilde{r}₀−r₀). The value of r₁ may be used as the new initial point of the search, for example, the value of r₁ is assigned to replace r₀, as the initial point, and the software may reiterate the search with value r₁.

Administrator module 250 may act generally to receive data from an administrative user via, for example, administrator device 130. Administrator module 250 may receive data from administrator device 130 associated with, for example, the objectives of the retailer or store, the currently available rewards associated with the objectives, the time period that the available rewards are available, the rewards available for a specified activity or activity category, or the reward score associated with a reward. Administrator module 250 may store received data in memory or pass available rewards to reward module 230 for further processing.

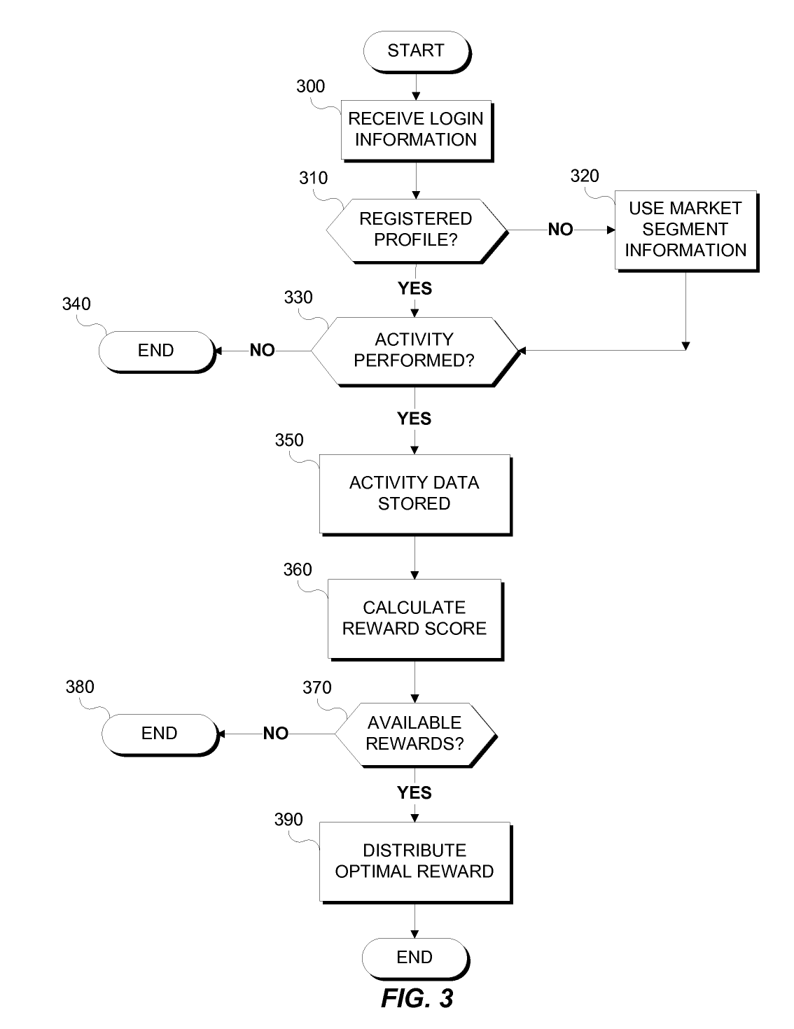

FIG. 3 is a flowchart depicting operational steps of a method of a dynamic rewards system on a server computer within the data processing environment of FIG. 1, for determining the rewards for specific customers, in accordance with an embodiment of the present invention. Referring now to FIGS. 1, 2, and 3, interface component 210 receives login information from a customer, for example, customer device 120, via server 110 (step 300).

Profile module 240 receives login information from interface component 210, via monitoring module 200. If there is a profile associated with the login information received from interface component 210 (decision step 310 “YES” branch), profile module 240 passes the profile information associated with the customer login information to reward module 230.

If there is no profile is associated with the customer login information received by interface component 210 (decision step 310 “NO” branch), profile module 240 passes the market segment information associated with the customer demographic to reward module 230. Reward module 230 calculates the rewards for any activity performed using statistically relevant market information based on, for example, age, gender, or location information received with the login information (step 320).

As described above, reward module 230 receives available rewards from administrator module 250 via administrator device 130. Reward module 230 may also receive rewards from another database, a rewards list in memory. Reward module 230 queries activity component 220 to determine if there is any activity data for the customer (decision step 330).

If an activity was performed by the customer (decision step 330 “YES” branch) then activity data is received by activity component 220, from the customer and passed to reward module 230 or stored in memory (step 350). If no activity was performed, no activity data will be received and the program ends (step 340).

Reward module 230 uses activity data from activity component 220 and profile information from profile module 240 to calculate the optimal reward score for the activity was performed (step 360). As described above with respect to equations 1-4, or 5 and 6, reward module 230 calculates the customer objective value, the customer's willingness to interact value, and the maximization of revenue value. If rewards are associated with the output reward score of reward module 230 (decision step 370 “YES” branch) reward module 230 determines which reward to be distributed based on the calculated reward score value. Reward module 230 passes the reward(s) to interface component 210 to distribute to the customer (step 390).

If reward module 230 has no available rewards (decision 370 “NO” branch) associated with the output reward score, a message will be communicated to customer device 120 via interface component 210 that there are no rewards available at that time and end (step 380).

FIG. 4 depicts a block diagram of components of server 110, customer device 120, and administrator device 130, of distributed data processing environment 100, of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Server 110, customer device 120, and administrator device 130, may include one or more processors 402, one or more computer-readable RAMs 404, one or more computer-readable ROMs 406, one or more computer readable storage media 408, device drivers 412, read/write drive or interface 414, network adapter or interface 416, all interconnected over a communications fabric 418. Communications fabric 418 may be implemented with any architecture designed for passing data and/or control information between processors (such as microprocessors, communications and network processors, etc.), system memory, peripheral devices, and any other hardware components within a system.

One or more operating systems 410, and one or more application programs 411, for example, reward application 111, are stored on one or more of the computer readable storage media 408 for execution by one or more of the processors 402 via one or more of the respective RAMs 404 (which typically include cache memory). In the illustrated embodiment, each of the computer readable storage media 408 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Server 110, customer device 120, and administrator device 130, may also include an R/W drive or interface 414 to read from and write to one or more portable computer readable storage media 426. Application programs 411 on server 110, customer device 120, and administrator device 130, may be stored on one or more of the portable computer readable storage media 426, read via the respective R/W drive or interface 414 and loaded into the respective computer readable storage media 408.

Server 110, customer device 120, and administrator device 130, may also include a network adapter or interface 416, such as a TCP/IP adapter card or wireless communication adapter (such as a 4G wireless communication adapter using OFDMA technology). Application programs 411 on server 110 may be downloaded to the computing device from an external computer or external storage device via a network (for example, the Internet, a local area network or other wide area network or wireless network) and network adapter or interface 416. From the network adapter or interface 416, the programs may be loaded onto computer readable storage media 408. The network may comprise copper wires, optical fibers, wireless transmission, routers, firewalls, switches, gateway computers and/or edge servers.

Server 110, customer device 120, and administrator device 130, may also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 may comprise hardware and software (stored on computer readable storage media 408 and/or ROM 406).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

What is claimed is:

1. A method for providing personalized rewards to users of a computer system, the method comprising:
receiving, by a computer, a set of current and historical electronic activity data of a customer corresponding to a customer's interaction with an electronic product entry;
identifying, by a computer, one or more electronic activities in a set of current and historical electronic activities that are associated with one or more predetermined seller objectives, wherein one or more seller objectives are based on maximizing financial profit and minimizing cost of reward distribution;
calculating a reward score value assigned to a customer based on associations between one or more electronic activities and the one or more predetermined seller objectives;
selecting, by a computer, a set of predetermined rewards associated with the one or more predetermined seller objectives based on the reward score value;
wherein rewards in the set of predetermined rewards are associated with the current and historical electronic activities; and
communicating, by a computer, the set of predetermined rewards to the customer.

2. The method of claim 1, wherein calculating the reward score value, further comprises:
calculating a second value based on a predetermined objective of the customer;
calculating a third value based on a cost to the customer to perform an activity;
calculating a fourth value based on a revenue of a seller; and
selecting the reward score value based on the second, third, and fourth calculated value.

3. The method of claim 2, wherein calculating the second value based on a predetermined objective of the customer further comprises:
determining a sixth value based on a number of activities that can be performed, by the customer;
determining a seventh value based on a number of rewards communicated, by a computer, to the customer;
determining an eighth value based on the number of activities performed by the customer; and
determining a ninth value based on a value the customer derives from available activities.

4. The method of claim 2, wherein calculating the third value based on the cost to the customer to perform the activity further comprises:
determining a sixth value based on a number of activities the customer can possibly perform;
determining a seventh value based on a cost to the customer an activity will incur; and
determining an eighth value based on an affect the reward has on the customer performing the activity.

5. The method of claim 2, wherein calculating the fourth value based on the revenue of the seller further comprises:
determining a sixth value based on a loss of revenue incurred by a seller for a reward distribution, and
determining a seventh value based on a total cost the seller is willing to incur for reward distribution.

6. The method of claim 1, wherein activity data includes one or more of:
an electronic comment;
an electronic review;
an electronic purchase;
a social media posting; and
completing an electronic survey.

7. The method of claim 1, wherein the rewards include one or more of:
a coupon,
monetary discount,
points,
percentage off of a product, and
an electronic customer acknowledgement on social media.

8. A computer program product for providing personalized rewards to users of a computer system, the computer program product comprising:
one or more computer-readable storage media and program instructions stored on the one or more computer-readable storage media, the program instructions comprising:
program instructions to receive a set of current and historical electronic activity data of a customer corresponding to a customer's interaction with an electronic product entry;
program instructions to identify one or more electronic activities in a set of current and historical electronic activities that are associated with the one or more predetermined seller objectives, wherein one or more seller objectives are based on maximizing financial profit and cost of reward distribution;
program instructions to calculate a reward score value assigned to a customer based on associations between the one or more electronic activities and the one or more predetermined seller objectives;
program instructions to select a set of predetermined rewards associated with the one or more predetermined seller objectives based on the reward score value;
wherein rewards in the set of predetermined rewards are associated with the current and historical electronic activities; and
program instructions to communicate the set of predetermined rewards to the customer.

9. The computer program product in accordance with claim 8, wherein program instructions to calculate a reward score value, further comprise:
program instructions to calculate a second value based on a predetermined objective of the customer;
program instructions to calculate a third value based on a cost to the customer to perform an activity;
program instructions to calculate a fourth value based on a revenue of a seller; and
program instructions to select the reward score value based on the second, third, and fourth calculated value.

10. The computer program product in accordance with claim 9, program instructions to calculate the second value based on a predetermined objective of the customer further comprises:
program instructions to determine a sixth value based on a number of activities that can be performed, by the customer;
program instructions to determine a seventh value based on a number of rewards communicated, by the computer, to the customer;
program instructions to determine an eighth value based on the number of activities performed by the customer; and
program instructions to determine a ninth value based on a value the customer derives from available activities.

11. The computer program product in accordance with claim 9, program instructions to calculate the third on the cost to the customer to perform the activity further comprises:
program instructions to determine a sixth value based on a number of activities a customer can possibly perform; and
program instructions to determine a seventh v value based on a cost to the customer an activity will incur; and
program instructions to determine an eighth value based on an affect the reward has on the customer performing the activity.

12. The computer program product in accordance with claim 9, program instructions to calculate the fourth value based on the revenue of the seller further comprises:
program instructions to determine a sixth value based on a loss of revenue incurred by a seller for a reward distribution, and
program instructions to determine a seventh value based on a total cost the seller is willing to incur for reward distribution.

13. The computer program product in accordance with claim 8, wherein activity data includes one or more of:
an electronic comment;
an electronic review;
an electronic purchase;
a social media posting; and
completing an electronic survey.

14. The computer program product in accordance with claim 8, wherein rewards includes one or more of:
a coupon,
monetary discount,
points,
percentage off of a product, and
an electronic customer acknowledgement on social media.

15. A computer system for providing personalized rewards to users of a computer system, the computer system comprising:
one or more computer processors;
one or more computer-readable storage media;
program instructions stored on the one or more computer-readable storage media for execution by at least one of the one or more computer processors, the program instructions comprising:
program instructions to receive, by the one or more computer processors, a set of current and historical electronic activity data of a customer corresponding to a customer's interaction with an electronic product entry;
program instructions to identify, by the one or more computer processors, one or more electronic activities in a set of current and historical electronic activities that are associated with one or more predetermined seller objectives, wherein the one or more seller objectives are based on maximizing financial profit and minimizing cost of reward distribution;
program instructions to calculate, by the one or more computer processors, a reward score value assigned to a customer based on associations between the one or more electronic activities and the one or more predetermined seller objectives;
program instructions to select, by the one or more computer processors, a set of predetermined rewards associated with the one or more predetermined seller objectives based on the reward score value;
wherein rewards in the set of predetermined rewards are associated with the current and historical electronic activities; and
program instructions to communicate, by the one or more computer processors, the set of predetermined rewards to the customer.

16. The system in accordance with claim 15, wherein program instructions to calculate a reward score value, further comprise:
program instructions to calculate, by the one or more computer processors, a second value based on a predetermined objective of the customer;
program instructions to calculate, by the one or more computer processors, a third value based on a cost to the customer to perform an activity;
program instructions to calculate, by the one or more computer processors, a fourth value based on a revenue of a seller; and
program instructions to select, by the one or more computer processors, the reward score value based on the second, third, and fourth calculated value.

17. The system in accordance with claim 16, program instructions to calculate the second value based on a predetermined objective of the customer further comprise:
program instructions to determine, by the one or more computer processors, a sixth value based on the number of activities that can be performed, by the customer;
program instructions to determine, by the one or more computer processors, a seventh value based on a number of rewards communicated, by a computer, to the customer;
program instructions to determine, by the one or more computer processors, an eighth value based on a number of activities performed by the customer; and
program instructions to determine, by the one or more computer processors, a ninth value based on a value the customer derives from available activities.

18. The system in accordance with claim 16, program instructions to calculate the third value based on a number of times the customer is willing to perform an activity further comprises:
program instructions to determine, by the one or more computer processors, a sixth value based on a number of activities a customer can possibly perform;
program instructions to determine, by the one or more computer processors, a seventh value based on a cost to the customer an activity will incur; and
program instructions to determine, by the one or more computer processors, an eighth value based on an affect the reward has on the customer performing the activity.

19. The system in accordance with claim 16, program instructions to calculate a seller revenue value based on a revenue of a seller further comprises:
program instructions to determine, by the one or more computer processors, a sixth value based on a loss of revenue incurred by a seller for a reward distribution, and program instructions to determine, by the one or more computer processors, a seventh value based on a total cost the seller is willing to incur for reward distribution.

20. The system in accordance with claim 15, wherein activity data includes one or more of:
an electronic comment;
an electronic review;
an electronic purchase;
a social media posting; and
completing an electronic survey.
